(19) United States
(12) Patent Application Publication
(10) Pub. No.: US 2022/0192326 A1
(43) Pub. Date: Jun. 23, 2022

(54) ASSEMBLY OF ELEMENTS SUCH AS LINKS OF A WRISTLET

(71) Applicant: Comadur SA, Le Locle (CH)

(72) Inventors: Paulo AREDE, La Chaux-de-Fonds (CH); Pierry VUILLE, Les Emibois (CH); Johan ROMAND, Mamirolle (FR); Maxime DOLE, Loray (FR)

(73) Assignee: Comadur SA, Le Locle (CH)

(21) Appl. No.: 17/492,957

(22) Filed: Oct. 4, 2021

(30) Foreign Application Priority Data
Dec. 22, 2020 (EP) 20216324.2

(51) Int. Cl. A44C 5/10

(52) U.S. Cl. CPC A44C 5/107; B22F 3/225

(57) ABSTRACT

A part (21), in particular a wristlet, including at least two sets (1) of elements (3, 5, 7), in particular links, assembled together. The securing between the elements (3, 5, 7) within a set and between sets is implemented via a gluing (15) rather than by a screwing. Also, a related method of manufacturing the part (21).

### CROSS REFERENCE TO RELATED APPLICATIONS

This application is claiming priority based on European Patent Application No. 20216324.2 filed on Dec. 22, 2020, the disclosure of which is incorporated herein in its entirely by reference.

### FIELD OF THE INVENTION

The invention relates to an assembly of elements and more precisely to a part comprising a plurality of sets of elements assembled together. The elements may form links of a wristlet, of a decorative item or of a jewellery item.

### PRIOR ART

In the horological or jewellery industry, varied materials are used for manufacturing wristlets of various appearances. Manufacturing wristlets from a hard material is in particular known. Hard material means materials having a Vickers hardness greater than 1000 HV. These hard materials are for example ceramic such as silicon nitride, zirconium oxide or aluminium oxide. It may also be a case of cermets. Hard materials are used for the mechanical properties thereof, in particular because they resist scratching well. The wristlet links produced from these materials are generally obtained after an injection step giving the required form to the link, and then by a sintering step for hardening the material.

Assembling wristlet links requires the presence of holes provided with a female thread on the link for screwing a screw or an element provided with a male thread. Machining these threads in a hard material is difficult.

Furthermore, producing a female thread requires complex moulds that limit the possibilities of injection on these links. Thus the injection point must be disposed on a face not comprising the female thread, i.e. on a visible face of the link. At this injection point, there may be defects such as segregations, or flow lines, and this in particular when coloured ceramics are injected. The presence of these defects on a visible face requires machining this face to eliminate the defects. It is therefore not possible to inject the link directly in its final form.

### SUMMARY OF THE INVENTION

The aim of the present invention is to overcome the aforementioned drawbacks by proposing a mounting without screwing between the links making it possible to avoid producing female threads in the link.

To this end, the invention relates to a part, in particular a wristlet, comprising at least two sets of elements, in particular links, assembled together. According to the invention, the attachment between the elements in a set and between sets is achieved via gluing rather than by screwing.

More precisely, the present invention relates to a part comprising at least two sets of elements assembled together, each set comprising a first, a second and a third element with the first element and the second element disposed on either side of the third element. The first and second elements each include first and second blind recesses and the third element includes a first and second through hole, the first through hole of the third element being placed facing the first blind recess of the first and second elements in each set, the second through hole of the third element of a set being placed facing the second blind recess of the first and second elements of another set. The attachment within each set and between the two sets is respectively provided by:
a first rod mounted in the first through hole of the third element and secured at its ends with a glue in the first blind recess of the first and second elements,
a second rod mounted in the second through hole of the third element and secured at its ends with said glue in the second blind recess of the first and second elements.

According to the invention, the blind recesses have a particular form that makes it possible to ensure the anchoring of the rods in the blind recesses. The first blind recess and the second blind recess delimit in a conventional manner a longitudinal zone for housing the end of the first and second rods. According to the invention, this longitudinal zone emerges on at least one cavity extending laterally with respect to said longitudinal zone. This cavity forms a recess where the glue is contained and fixed around the end of the rods, which ensures firm holding thereof in the recess.

Preferably, said first blind recess and said second blind recess each delimit two cavities extending laterally with respect to the longitudinal zone, the two cavities being respectively positioned on each side of the longitudinal zone.

Thus the cavity or cavities make it possible to achieve a mechanical attachment between the glue and the links, which makes it possible to firmly secure the various sets.

Furthermore, securing by gluing reduces the costs of assembly of the wristlet and simplifies the assembly.

The absence of a female thread in the blind recesses also makes it possible to simplify the injection mould with as a corollary the fact that the injection point can be on the face comprising the blind recesses, i.e. on a non-visible face. This makes it possible to avoid the machining step and to directly inject the link to the correct shape.

According to particular embodiments of the invention, the part has one or a suitable combination of the following features:
the two cavities are positioned one facing the other on each side of the longitudinal zone;
the longitudinal zone extends on either side of said at least one cavity;
the first rod and the second rod include, at the ends thereof, a head provided with a notch over the periphery thereof, said notch being filled with the glue and positioned opposite said at least one cavity;
at least one portion of the first and second elements is produced from an enamel, a stone, a sapphire, a cermet or a ceramic;
in each set, the third element is formed by a plurality of elements with an intermediate element disposed between each of said plurality of elements;
the first through hole and/or the second through hole of the third element include a cross section of non-circular shape corresponding to the shape respectively of the first and second rods in order to prevent any relative pivoting of the first, second and third elements;
the first through hole and the second through hole of the third element include a cross section with a circular shape corresponding to that of the first and second rods in order to allow the pivoting of the third element with respect to the first and second elements;
it includes at least five elements connected together;
it is a case of a wristlet, a decorative item or a jewellery item.

The present invention also relates to the method for manufacturing the part including a step of producing at least one of the first, second and third elements by additive manufacturing or by injection and sintering and including a step of assembling and securing the first, second and third elements by gluing.

According to a particular embodiment of the method, the first element and the second element are produced by injection and sintering in accordance with the following steps:

a) a step of producing a precursor from a mixture of at least one material in powder form with a binder,
b) a step of producing an insert made from polymer material, the insert having at least partly a negative form of the first and second blind recesses,
c) a step of overmoulding the precursor on the insert made from polymer material by injection in a mould in order to form an unfired body, and
d) a step of sintering said unfired body in order to form said first element and second element in said material.

Other features and advantages of the present invention will emerge in the following description of a preferred embodiment, presented by way of non-limitative example with reference to the accompanying drawings.

### BRIEF DESCRIPTION OF THE FIGURES

FIG. 1 is a view in cross section of a part according to the invention with assembly by gluing between the links.

FIG. 2 is a plan view of another part according to the invention with assembly by gluing between the links,

FIGS. 3a and 3b illustrate the step of securing the rod in a link by gluing.

FIG. 4 is block diagram of the method for producing the links provided with a blind recess.

FIGS. 5a to 5c show views in schematic cross section of a link obtained according to the method of FIG. 4.

FIG. 6 is a perspective view of a link according to the invention.

### DETAILED DESCRIPTION

The present invention relates to an assembly of elements that are, for example, links intended to form a wristlet, a decorative item or a jewellery item. The assembly is more specifically adapted for elements produced in whole or in part with hard materials. The term “hard materials” according to the invention designates materials the hardness of which is substantially equal to or greater than 600 HV, or even equal to or greater than 1000 HV, and which accept plastic deformation only a little or not at all before breaking. Mention can be made, by way of in no way limitative example, as hard materials, for example, of enamels, stones, precious or not, such as ruby, sapphire or quartz, ceramics such as a metallic or non-metallic oxide, carbide or nitride, cermets or hard metals.

The part according to the invention, which is illustrated below for a wristlet, includes at least two sets of elements assembled together. According to the invention, the securing between the elements in a set and between sets is achieved by gluing.

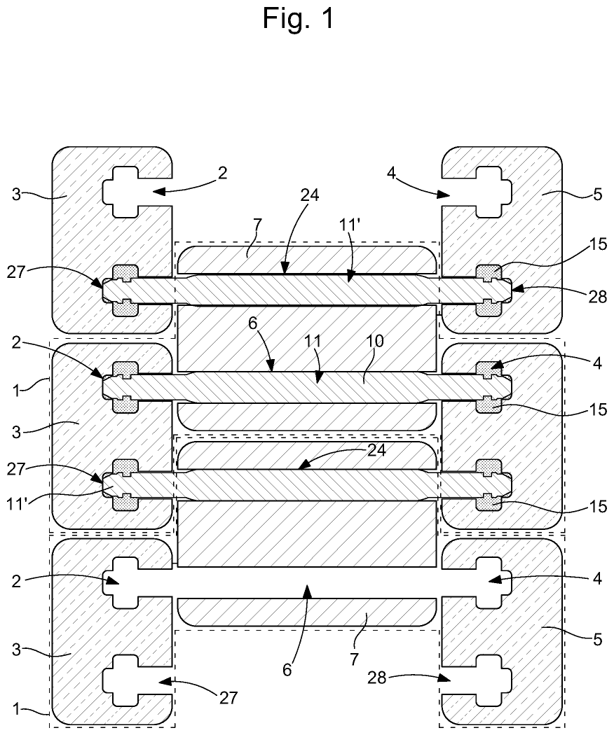

Each set 1, delimited by broken lines in FIG. 1, includes at least three elements 3, 5, 7 that can be formed in whole or in part from hard materials. It includes a first lateral element 3 and a second lateral element 5 both substantially symmetrical with respect to a third element 7 disposed between the lateral elements. It should be noted that the elements 3, 5, 7 are preferentially mounted in a zigzag.

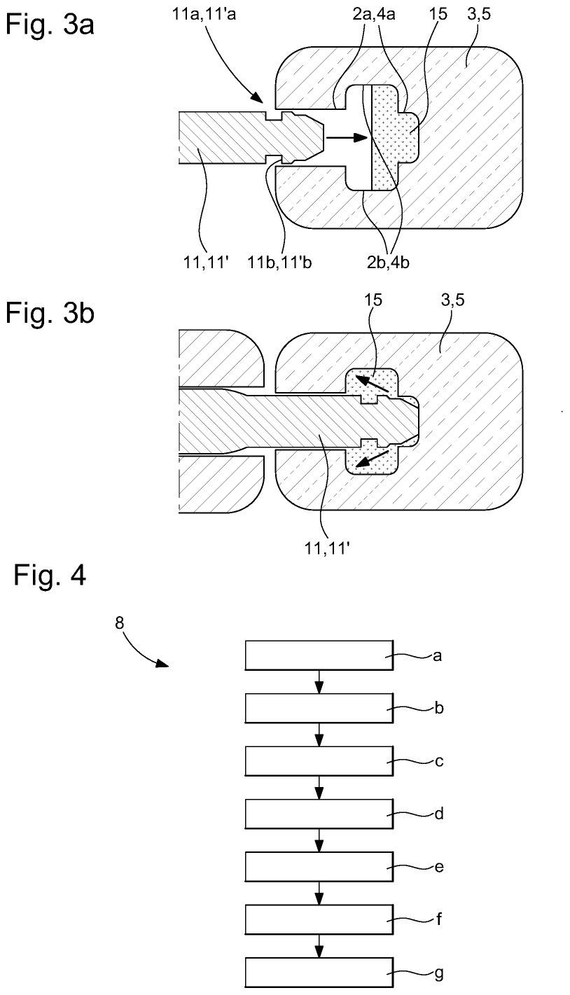

The first and second elements 3, 5 each include a first blind element 2, 4 whereas the third element 7 includes a first through hole 6. As shown in FIG. 1, the recesses 2, 4 and the hole 6 are intended to be aligned in order to secure the first, second and third elements 3, 5, 7 together via a rod 11 mounted in the through hole 6 of the central third element 7 and glued at the ends thereof in the recesses 2, 4. The blind recesses 2, 4 delimit a longitudinal zone 2a, 4a for housing the ends of the rod 11 and at least one cavity 2b, 4b extending laterally with respect to said longitudinal zone (FIG. 3a). This cavity receives the glue 15 for providing a mechanical attachment of the glue in the first and second elements (FIG. 3b). There are preferably two lateral cavities 2b, 4b disposed on either side of the longitudinal zone 2a, 4b and preferentially facing each other. Still preferably, the longitudinal zone 2a, 4a extends on either side of the cavities 2b, 4b with the end of the rod 11 bearing against the end of the longitudinal zone 2a, 4a.

Furthermore, preferably, the rod 11 includes at the ends thereof a head 11a with a notch 11b provided over the entire periphery thereof. This notch is filled with the glue and disposed opposite the cavities. The rod 11 includes a main part 10 received in the through hole 6 of the third element 7 (FIG. 1). According to the clearance left or the respective shapes of the through hole 6 and portion 10, the first and second lateral elements 3, 5 can pivot or not with respect to the central third element 7. By way of in no way limitative example, the through hole 6 may include a cross section of circular shape corresponding to that of the central part 10 of the rod 11 in order to prevent any relative pivoting of the first, second and third elements 3, 5, 7. On the other hand, it may be envisaged for the through hole 6 to include a cross section with a circular shape corresponding to that of the part 10 of the rod 11 in order to allow pivoting of the central third element 7 with respect to the first and second lateral elements 3, 5.

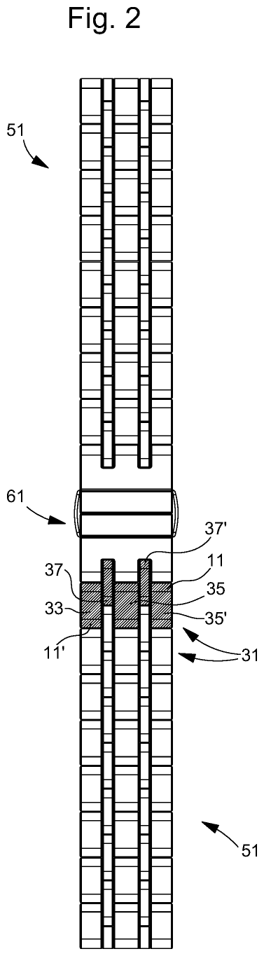

In a variant presented in FIG. 2, each set 31 includes five elements. This is because, in addition to the three elements 33, 35′, 37 comparable to those 3, 5, 7 of the first type of set 1, the set 31 of the second type includes an intermediate row with a central second element 37′ and an intermediate element 35.

The set 1, 31 is assembled with another set and so on so as to form a part such as, for example, a wristlet, a decorative item or a jewellery item. As shown in FIG. 2, a plurality of sets 31 can be connected together by a clasp 61 in order to form a wristlet intended to be mounted on a timepiece middle.

The two sets 1, 31 are also connected together via a rod 11′ mounted in a second through hole 24 in the third element 7 of a set 1. Each end of the rod 11′ is mounted and glued respectively in a second blind recess 27, 28 formed in a first and second element 3, 5 of another adjacent set 1. The rod 11′ intended to be mounted in the second through hole 24 has a configuration similar to the one intended to be mounted in the first through hole 6. Likewise, the blind recesses 27, 38 have the same features as the blind recesses 2, 4.

It will be understood that, as with the first through hole 6, depending on the clearance left or the respective form of the through hole 24 and of the rod 11′, the central third element 7 will be able to pivot or not with respect to the first and second lateral elements 3, 5 that frame it. Just as with the first through hole 6, the through hole 24 may include a cross section with a non-circular shape corresponding to that of the rod 11′ in order to prevent any relative pivoting between the third element and the first and second lateral elements. On the other hand, it can be envisaged that the through hole 24 may include a cross section with a circular shape corresponding to that of the rod 11′ in order to allow such relative pivoting.

The method for mounting the sets 1 is explained below. Initially, the elements 3, 5, 7 are manufactured with the various holes or recesses 2, 4, 6, 27, 28, 24. Preferably, at least one of the elements 3, 5 with the blind recesses 2, 4, 27, 28 are produced by additive manufacturing or by injection and sintering in accordance with a method described in further detail below. Secondly, the rods 11, 11′ are mounted and fixed by gluing respectively in the recesses 2 and 27 of the lateral element 3 (FIG. 3a and FIG. 3b). The glue may, for example, by an epoxy glue with a viscosity >400 Pa·s and a tensile strength >40 N/mm². The gluing is implemented by deposition with a syringe under pressure. Thirdly, the portions of the rods 11, 11′ projecting from the first lateral element 3 are fitted respectively with regard to the first rod 11 in the first through hole 6 in a third element 7 of a set 1 and with regard to the second rod 11′ in the second through hole 24 in the third element 7 of an adjacent set 1. Fourthly, the second end of each rod 11, 11′ projecting from the third elements 7 is mounted and secured by gluing in the recesses 4 and 28 of the second lateral element 5. The end of the fourth stage, the elements 2, 5 and 7 within each set are completely secured together, as are the sets completely secured to each other.

When there are more than three elements as illustrated in FIG. 2, the principle is substantially the same with the elements 37, 37′ forming the third central element. The first and second through holes in these elements 37, 37′ communicate with two through holes formed respectively in the intermediate elements 35 of two adjacent sets 31 for receiving respectively the two rods 11, 11′ extending between the lateral elements 33, 35′ provided with the blind recesses.

As explained above, the lateral elements 3, 5 with the blind recesses can be produced by additive manufacturing or by injection and sintering. The blind recesses can be produced directly during the additive manufacturing. For manufacturing by injection and sintering, the lateral elements with the blind recesses can be produced by overmoulding of the hard material on an insert made from lost plastics material having the form of the recesses in accordance with the application EP 20194714. In accordance with this application and as shown schematically in FIG. 4, the method 8 comprises a first step of producing a) a precursor from a mixture of at least one hard material that is in powder form with a binder. In this context, the ceramic-based powder may include at least one metal oxide, a metal nitride or a metal carbide. By way of example, the ceramic-based powder may include aluminium oxide or a mixture of aluminium oxide and chromium oxide in order to form synthetic ruby, zirconium oxide, which optionally may be pigmented, alumina, which may optionally be pigmented, silicon nitride, cermets, metals and composites of these metals. The cermets are for example titanium carbide or tungsten carbide. The metals are for example tungsten, titanium, 316L stainless steel or steel, preferably nickel-free. The binder is of the organic type.

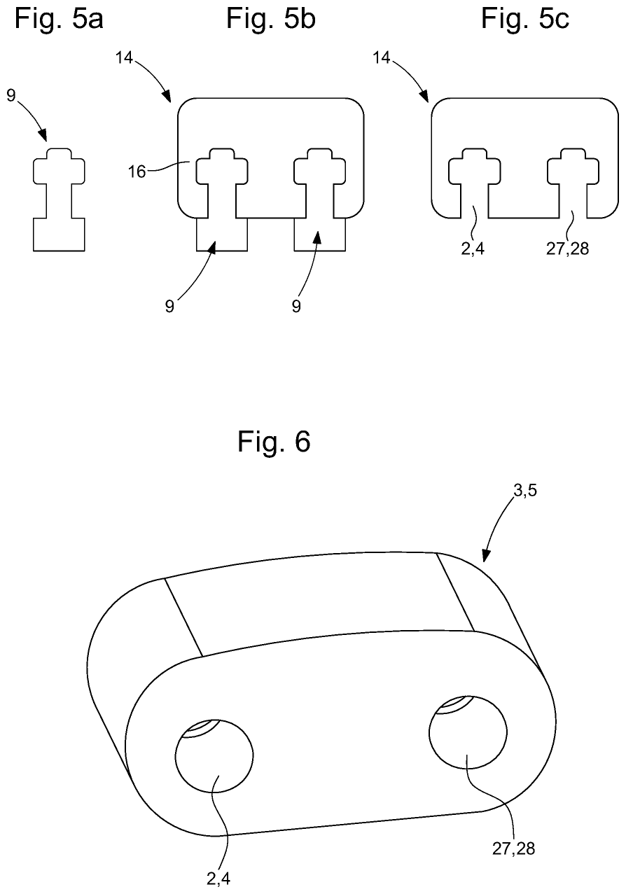

The method 8 comprises a second step of producing b) an insert 9 made from polymer material, the insert having at least partly a form that is a negative of the one required for the recesses of the lateral elements 3, 5 (FIG. 5a). The polymer is for example selected from the following list: PVD (standing for plasticised polyvinyl butyral), CAB (standing for plasticised cellulose acetate butyrate), or acrylic resin of the PBMA type (standing for polybutyl methacrylate).

A third step c) consists in overmoulding the precursor 16 on the insert 9 made from polymer material in order to form the unfired body 14 (FIG. 5b). The overmoulding is in particular implemented by injection in a mould. The mould has at least partly the form of the required part taking account of a coefficient of shrinkage of the part. The precursor is injected into the mould through a tube, and then through circuits for distributing the precursor in the whole of the mould. The precursor thus adopts the form of the mould, which is that of the lateral elements. As an alternative, it is also possible to implement the injection by circular sheet or by channels. The unfired body adapts the form of the mould and at least partly the form of the insert on which it is overmoulded.

In a fourth step d), the unfired body is machined in order to eliminate unnecessary portions of the unfired body produced by the injection. For example, a nozzle or channels formed because of the tube or distribution circuits of the injection system are eliminated. Thus a machined unfired body is obtained.

In a fifth step e), the polymer insert 9 is eliminated by thermal debinding. Preferably, the unfired body overmoulded on the insert is immersed in a bath of alcohol at 80°. The bath of alcohol dissolves the polymer insert, so that the unfired body is obtained with the required form given by the insert. Alternatively, it is possible to implement thermal debinding to eliminate the polymer insert. The body overmoulded on the insert is thus heated to high temperature to make the polymer disappear. The polymer insert is consequently removed from the unfired body. The insert leaves a positive shape in the unfired body 14, which is that of the blind recess 2, 4, 27, 28 (FIG. 5c).

The function of the sixth step f) is to sinter said machined unfired body in order to form a body of the future part in said at least one hard material. The sintering consists in heating the precursor so that the powder grains agglomerate. During the sintering, the unfired body hardens while shrinking so as to result in a hard body with a sintering coefficient. Preferentially, according to the invention, the sintering step may include a pyrolysis. The body of the part obtained is substantially hardened by this step. Thus the body of the part has a definitive form as shown in FIG. 6.

A seventh step g) may also be necessary to proceed with a glazing and/or polishing of the hard material. Thus the aesthetic appearance of the lateral element is improved.

Next the lateral elements are assembled in each set in accordance with the assembly method described above.

In a variant, for manufacturing by injection and sintering as well as for additive manufacturing, the blind recesses may be produced by machining in the unfired body or in the hard body after sintering.

The central element 7 may also be manufactured by additive manufacturing, or by injection and sintering.

1. A part (21, 51) comprising at least two sets (1, 31) of elements (3, 5, 7, 33, 35, 35′, 37, 37′) assembled together, each set (1, 31) including a first (3, 33), a second (5, 35′) and a third (7, 37, 37′) element with the first element (3, 33) and the second element (5, 35′) disposed on either side of the third element (7, 37, 37′), the first (3, 33) and the second (5, 35′) elements each including a first (2, 4) and a second blind recess (27, 28) and the third element (7, 37, 37′) including a first (6) and a second (24) through hole, the first through hole (6) of the third element (7, 37, 37′) being placed facing the first blind recess (2, 4) of the first (3, 33) and second (5, 35′) elements in each set (1, 31), the second through hole (24) of the third element (7, 37, 37′) of a set (1, 31) being placed facing the second blind recess (27, 28) of the first (3, 33) and second (5, 35′) elements of another set (1, 31), the attachment within each set (1, 31) and between the two sets (1, 31) being respectively provided by:
a first rod (11) mounted in the first through hole (6) of the third element (7, 37, 37′) and secured at its ends in the first blind recess (2, 4) of the first (3, 33) and second (5, 35′) elements, and
a second rod (11′) mounted in the second through hole (24) of the third element (7, 37, 37′) and secured at its ends in the second blind recess (27, 28) of the first (3, 33) and second (5, 35′) elements,
wherein:
said first rod (11) and said second rod (11′) are respectively secured in the first blind recess (2, 4) and in the second blind recess (27, 28) with a glue (15), and
said first blind recess (2,4) and said second blind recess (27, 28) form a longitudinal zone (2a, 4a) for respectively housing the ends of the first (11) and of the second (11′) rod, said longitudinal zone (2a, 4a) emerging on at least one cavity (2b, 4b) extending laterally with respect to said longitudinal zone (2a, 4a), said cavity (2b, 4b) accommodating the glue (15) and providing a mechanical attachment of the glue (15) in the first (3, 33) and second (5, 35′) elements, and wherein said longitudinal zone (2a, 4a) emerges on two cavities (2b, 4b) extending laterally with respect to the longitudinal zone (2a, 4a), the two cavities (2b, 4b) being respectively positioned on each side of the longitudinal zone (2a, 4a).

2. The part (21, 51) according to claim 1, wherein the two cavities (2b, 4b) are positioned one facing the other on each side of the longitudinal zone (2a, 4a).

3. The part (21, 51) according to claim 1, wherein the longitudinal zone (2a, 4a) extends on either side of said at least one cavity (2b, 4b).

4. The part (21, 51) according to claim 1, wherein the first rod (11) and the second rod (11′) include, at the ends thereof, a head (11a, 11′a) provided with a notch (11b, 11′b) over the periphery thereof, said notch (11b, 11′b) being filled with the glue (15) and positioned opposite said at least one cavity (2b, 4b).

5. The part (21, 51) according to claim 1, wherein at least one portion of the first and second elements (3, 5, 33, 35′) is produced from an enamel, a stone, a sapphire, a cermet or a ceramic.

6. The part (21, 51) according to claim 1, wherein, in each set, the third element (7, 37, 37′) is formed by a plurality of elements (37, 37′) with an intermediate element (35) disposed between each of said plurality of elements (37, 37′).

7. The part (21, 51) according to claim 1, wherein the first through hole (6) and/or the second through hole (24) of the third element (7, 37, 37′) include a cross section of non-circular shape corresponding to the shape respectively of the first and second rods (11, 11′) in order to prevent any relative pivoting of the first, second and third elements (3, 5, 33, 35′, 7, 37′, 37).

8. The part (21, 51) according to claim 1, wherein the first through hole (6) and the second through hole (24) of the third element (7, 37, 37′) include a cross section with a circular shape corresponding to that of the first and of the second rods (11, 11′) in order to allow the pivoting of the third element (7, 37, 37′) with respect to the first and second elements (3, 5, 33, 35′).

9. The part (21, 51) according to claim 1, wherein the part includes at least five sets (1, 31) connected together.

10. The part (21, 51) according to claim 1, wherein the part is a case of a wristlet, a decorative item or a jewellery item.

11. A method for manufacturing a part (21, 51) comprising at least two sets (1, 31) of elements (3, 5, 7, 33, 35, 35′, 37, 37′) assembled together, each set (1, 31) including a first (3, 33), a second (5, 35′) and a third (7, 37, 37′) element with the first element (3, 33) and the second element (5, 35′) disposed on either side of the third element (7, 37, 37′), the first (3, 33) and the second (5, 35′) elements each including a first (2, 4) and a second blind recess (27, 28) and the third element (7, 37, 37′) including a first (6) and a second (24) through hole, the first through hole (6) of the third element (7, 37, 37′) being placed facing the first blind recess (2, 4) of the first (3, 33) and second (5, 35′) elements in each set (1, 31), the second through hole (24) of the third element (7, 37, 37′) of a set (1, 31) being placed facing the second blind recess (27, 28) of the first (3, 33) and second (5, 35′) elements of another set (1, 31), the attachment within each set (1, 31) and between the two sets (1, 31) being respectively provided by:
a first rod (11) mounted in the first through hole (6) of the third element (7, 37, 37′) and secured at its ends in the first blind recess (2, 4) of the first (3, 33) and second (5, 35′) elements,
a second rod (11′) mounted in the second through hole (24) of the third element (7, 37, 37′) and secured at its ends in the second blind recess (27, 28) of the first (3, 33) and second (5, 35′) elements,
wherein:
said first rod (11) and said second rod (11′) are respectively secured in the first blind recess (2, 4) and in the second blind recess (27, 28) with a glue (15),
said first blind recess (2,4) and said second blind recess (27, 28) form a longitudinal zone (2a, 4a) for respectively housing the ends of the first (11) and of the second (11′) rod, said longitudinal zone (2a, 4a) emerging on at least one cavity (2b, 4b) extending laterally with respect to said longitudinal zone (2a, 4a), said cavity (2b, 4b) accommodating the glue (15) and providing a mechanical attachment of the glue (15) in the first (3, 33) and second (5, 35′) elements, and wherein said longitudinal zone (2a, 4a) emerges on two cavities (2b, 4b) extending laterally with respect to the longitudinal zone (2a, 4a), the two cavities (2b, 4b) being respectively positioned on each side of the longitudinal zone (2a, 4a),
wherein the method includes a step of producing at least one of the first (3, 33), second (5, 35′) and third (7, 37, 37′) elements by additive manufacturing or by injection and sintering, and wherein it includes a step of assembling and securing the first (3, 33), second (5, 35′) and third (7, 37, 37′) elements by gluing.

12. The manufacturing method according to claim 11, wherein the first element (3, 33) and the second element (5, 35′) are produced by injection and sintering in accordance with the following steps:
a) a step of producing a precursor (16) from a mixture of at least one material in powder form with a binder,
b) a step of producing an insert (9) made from polymer material, the insert (9) having at least partly a negative form of the first (2, 4) and second blind recesses (27, 28),
c) a step of overmoulding the precursor (16) on the insert (9) made from polymer material by injection in a mould in order to form an unfired body (14), and
d) a step of sintering said unfired body (14) in order to form said first element (3, 33) and second element (5, 35′) in said material.
